(19) United States
(12) Patent Application Publication
(10) Pub. No.: US 2005/0187823 A1
(43) Pub. Date: Aug. 25, 2005

(54) Method and system for geographically-targeted internet advertising

(76) Inventor: Jeffrey V. Howes, Fulton, MD (US)

Correspondence Address: BRUCE E. WEIR, 12 SPARROW VALLEY COURT, MONTGOMERY VILLAGE, MD, 20886-1265, US

(21) Appl. No.: 10/966,989

(22) Filed: Oct. 16, 2004

Related U.S. Application Data
(60) Provisional application No. 60/546,177, filed on Feb. 23, 2004.

(51) Int. Cl. G06F 17/60

(52) U.S. Cl. 705/14

(57) ABSTRACT

A web advertiser may geographically target internet display advertising by selecting geographic parameters. Fragments of geographic location data are supplied by or inferred about a computer user accessing a web publisher's web site. User information is transmitted by the web publisher to an advertising server, where it is supplemented by comparison with a geographic information database. User information is then compared to geographic parameters supplied by the advertiser. If a match is found, a geographically-targeted advertisement is transmitted to the user. If no match is found, a default advertisement is transmitted to the user. Advertising inventory from many advertisers may be aggregated on the advertising server and delivered through many web publishers to users in specified geographic locations.

### CROSS-REFERENCE TO RELATED APPLICATION

This application claims priority from provisional patent application Ser. No. 60/546,177, filed Feb. 23, 2004 by the same inventor, now pending.

### COMPUTER PROGRAM LISTING APPENDIX

A computer program listing appendix containing files comprising versions of computer program code used to implement the present invention is incorporated herein by reference and is appended hereto in the form of two identical compact discs, an original and a copy. Each disk contains the following files:

| Filename | Size | Date of Creation |
|---|---|---|
| geoad_html.txt | 10 KB | Feb. 23, 2004 |
| getad_geo.txt | 10 KB | Feb. 17, 2004 |
| getCID_geo_nopop.txt | 4 KB | Feb. 17, 2004 |

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Most advertising campaigns are specific to selected geographic areas. The inherent limitations of television, radio, and print media distribution systems allow advertisers to direct advertising content to those geographic areas. Advertisers may wish to target Internet advertising campaigns to selected geographic areas in much the same manner. However, an advertiser rarely has the means to target a locality for Internet advertising without help from an internet advertising provider who can identify the location of an advertising target and deliver desired advertising content.

Such providers face many challenges. The Internet is not geographically segmented in any uniform manner, making delivery to only specific regions difficult. Some internet advertising providers attempt to locate advertising targets by IP address, but IP addresses do not correlate reliably with specific geographic locations.

IP addresses are randomly assigned without regard to geographic region. To compensate, some providers have established databases that map IP addresses and IP address blocks to specific geographic regions. This method is only accurate to wide areas, and in many cases is not an accurate indication of the actual location of an end user at all. An IP address can only be mapped to an Internet Service Provider (ISP), not to the end user, so certain assumptions are made that, in some cases, may be accurate with regard to the general area of the user, such as country and state, but not to the specific area, such as city, zip code, or direct market area (DMA).

Further, in many cases, the IP address location may be a completely incorrect representation of the end user's actual location. For example, IP address mapping would indicate that most of the current 34,000,000 AOL subscribers are located in Virginia, when in actuality, they are located throughout the country. Similarly, many other large internet service providers have centralized servers, not necessarily located near their end users. Rarely can IP address mapping can accurately indicate an end user's location in a unit smaller than a state.

Also, even if an IP address or other location-determining means is assumed to correctly identify the location of an advertising target, most existing systems for supplying advertising content provide geographic targeting only within a single web site or group of web sites operated by a single web publisher. Such systems do not give advertisers a means of purchasing geographically targeted campaigns that utilize many web publishers through a single provider.

Existing systems are available to enable advertisers to make ad placements on multiple web sites by selecting the specific web sites, pages, uniform resource locators (URLs), channels, or sections on which they want to display their advertisement. With these systems, if an advertiser wants to geographically restrict traffic, specific placements must be manually selected. Such placements are only “loosely” geographically targeted by content because the web publisher's site does not dynamically transmit actual end user geographic data.

### SUMMARY

The present invention provides advertisers with a system that greatly improves the accuracy of end user location data and delivers ad content to many different web publishers serving the targeted geographic area. End user location data is collected at web publisher sites that provide weather data, telephone directories, search engines, and other services where end users enter geographic and other data into search forms to request specific information. Other web sites require users to enter such data when registering to use the web site. Still other web sites may have content that is restricted or targeted to a specific geographic area.

The present invention provides access to many web publishers by aggregating the regional ad inventory of participating web publishers, allowing an advertiser who desires a regional campaign to place advertising in all appropriate positions with one transaction. Each participating web publisher also benefits from the present invention. Accurate geographic targeting tends to increase the advertising value of a web publisher's site. Additionally, a participating web publisher is likely to receive revenue from advertisers who would otherwise not have utilized the web publisher's site at all. Web publishers also benefit from pooling geotargeted advertiser inventory, which reduces time spent on selling and contract with many different advertisers. Publishers not presently capable of geotargeting may now offer geotargeted campaigns.

The present invention uses concise, specific data, usually entered by an end user, to accurately display advertising campaigns in desired geographic areas such as states, cities, zip codes, DMA, and telephone area codes. The present invention in effect creates a geographically segmented network of separately-owned advertising venues, permitting the purchase of advertising based on geographic region alone, with the web publisher being transparent to the advertiser.

When an end user accesses the web site of a participating web publisher, end user location data is coded in an ad request string that is sent by the site to one or more central ad servers. Each ad server parses ad request strings into information needed to return an advertisement to the end user via the Internet, with the method for constructing an ad request string dependent on whether user location data is derived from a data request form, registration form, or inferred from geographic limitations inherent in the web publisher's site.

Other embodiments of the present invention may include additional algorithms for matching ad request strings with a particular campaign according to content, demographics, keywords, ad view frequencies, and other criteria. The present invention may also include trafficking, tracking, recording, reporting, and billing features needed to provide both advertisers and web publishers with online data reports, advertising creative management features, and detailed billing and payment disbursement. The system issues consolidated invoices to advertisers, including combined data for all advertising placements and detailed breakdowns for each specific placement.

All of these features and advantages of the present invention, and more, are illustrated below in the drawings and detailed description that follow.

### BRIEF DESCRIPTION OF THE DRAWINGS

FIG. 1 shows a schematic block diagram of a preferred embodiment of the present invention.

FIG. 2 shows examples of dialog boxes commonly used for data entry on web sites.

FIG. 3 shows a flow diagram for an embodiment of the present invention wherein geographic information collected on an end user may be stored as a cookie on the end user's system.

FIG. 4 shows a flow diagram for geoad_html.asp, a script that a web publisher would point to with an ad request string.

FIG. 5 shows a flow diagram for getad_geo.sql, which is called by geoad_html.asp.

FIG. 6A shows a first portion of a flow diagram for getCID_geo_nopop.sql, which is a script called by getad_geo.sql.

FIG. 6B shows a second portion of a flow diagram for getCID_geo_nopop.sql.

FIG. 6C shows a third portion of a flow diagram for getCID_geo_nopop.sql.

### DETAILED DESCRIPTION

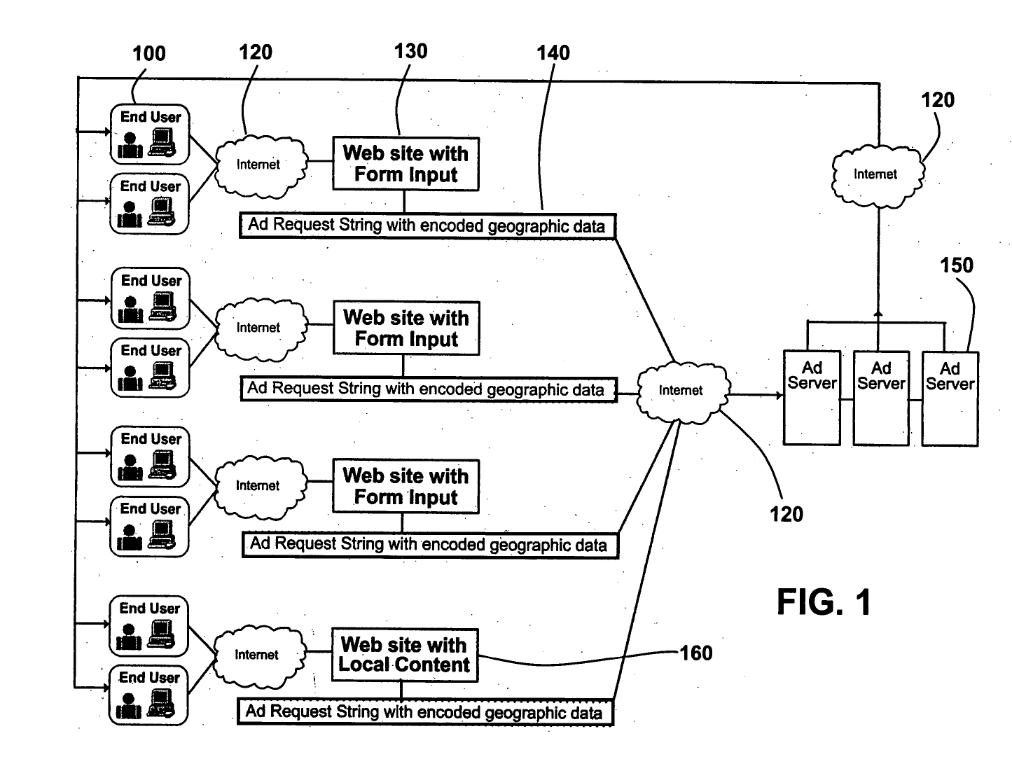

FIG. 1 shows a schematic block diagram of a preferred embodiment of the present invention. An end user 100 is a potential advertising target. The end user 100 utilizes a personal computer or workstation to access a web site 130 via the Internet 120. Any computer supporting a well-known web browser such as INTERNET EXPLORER®, NETSCAPE NAVIGATOR®, MOZILLA®, OPERA®, or FIREFOX® will serve. The web site 130 can be any web site to which an end user 100 knowingly or unknowingly provides some information that may be correlated with an identifiable geographic area.

Common examples of such web sites are those providing weather data, telephone directories, search engines, television listing services, shopping directories, internet services, internet email, and community services. A user accessing a web site with a geographically-defined user base, such as a local newspaper web site, may provide inferred geographic information even in the absence of other input. The owners or operators of web sites are referred to as web publishers.

Once an end user's geographic location has been established and related records created, advertising inventory relevant to that geographic area must be delivered. However, the highly fragmented nature of the web poses significant ad placement problems for both advertisers who wish to purchase advertising exposure and web publishers who wish to provide it. An unassisted advertiser wishing to advertise in a given geographic venue would have to identify and contact web publishers serving that venue and contract separately with each for advertising services. Since web ads tend to be both ephemeral and inexpensive, this approach is often not cost-effective.

One manner in which the present invention addresses this problem is by aggregating the regional ad inventory of many web publishers by any desired and available combination of geographic parameters, so that an advertiser who desires a regional campaign can effectively place advertising with all participating web publishers within a venue with one transaction. Thus, for example, MCDONALD'S® may run a certain promotion only in certain states without the prohibitive cost and effort of identifying and contracting with each individual web publisher within each selected state.

Further, Joe's Hardware, a store with only one location, can choose to target only three adjacent zip codes via the web, whereas previously the store might have been forced to rely on expensive radio or newspaper advertising that reaches many listeners or viewers outside of the store's business territory. The present invention, in effect, creates a geographically segmented network of separately owned advertising venues and permits the purchase of advertising based on geographic region alone, with the network of web publishers being transparent to the advertiser.

A web publisher utilizes the system by contracting with an internet advertising provider who supports the present invention. When a participating web publisher's site is accessed by an end user 100, Hypertext Markup Language (HTML) code embedded in at least one web page on the web publisher's site 130 sends an ad request string via the internet 120 to a central ad server 150 utilized by an advertising provider. The ad server 150, in turn, parses ad request strings and sends an appropriate advertisement or advertisements back to the end user's 100 web browser via the internet 120. If geographic or other specified characteristic information is available, the ad server returns one or more ads corresponding to that information. If no useful information is available, or there are no advertisements available that match the request, the ad server responds with a “default” advertisement provided by the web publisher.

Depending on anticipated web traffic, an ad server 150 may consist of a single server or a server farm containing many individual servers, with the load between servers balanced by switches. A suitable server might contain a dual-CPU, 2 GigaHertz INTEL® XEON® processor with 8 Gigabytes of RAM and a 500 GigaByte hard disk, and might run under a Linux, Unix, WINDOWS®, or other well-known operating system.

The method used for constructing an ad request string will depend on the web publisher's geographic targeting capability. If the ad request string is generated from data entered into a form by an end user, certain parameters are dynamically embedded in the URL of the ad request string. If the publisher is using a user registration form to obtain user data, the necessary parameters may be stored on the end user's system in a cookie, for later transmission to the central server when an ad request is made. Ad requests are typically made via a URL embedded on the web publisher's web page. As it is possible that cookies may be deleted from time to time, web publishers may optionally embed scripts into their web pages that restore a missing cookie. If a web publisher's site has geographically-targeted content, the necessary parameters may be “hard coded” (embedded) into the ad request URLs the web publisher uses to request ads.

Upon receiving ad request strings from web sites, a central server parses URL and cookie data into variables and values needed by the system's software to determine which advertisement to display, based on data transmitted in the URL and in the cookie, and the specified criteria of active advertising campaigns. Other embodiments of the invention may include certain additional algorithms for matching the ad requests with a particular campaign, such as content, demographic, keyword, ad view frequency, and other criteria.

The present invention also includes trafficking, tracking, recording, reporting, and billing features to provide both the advertiser and web publisher online data reports, advertising creative management features, and detailed billing and payment disbursement. The system issues consolidated invoices to advertisers, including combined data for all advertising placements and detailed breakdowns for each specific placement.

An embodiment of the invention may include other dynamic, user-entered data in addition to, or instead of, geographic information. Other data may include keywords entered by the user and/or name/value pairs embedded by a web publisher into an ad request string that contain codes indicating content type, user preferences, and user demographic characteristics. Codes transmitted in a URL or cookie with the ad request string are from predefined lists associated with the system. Another embodiment of the invention may replace a geographic parameter with a keyword parameter, thus enabling advertisers to purchase pooled, keyword-targeted inventory across multiple web sites that are capable of sending ad requests containing user-entered keywords.

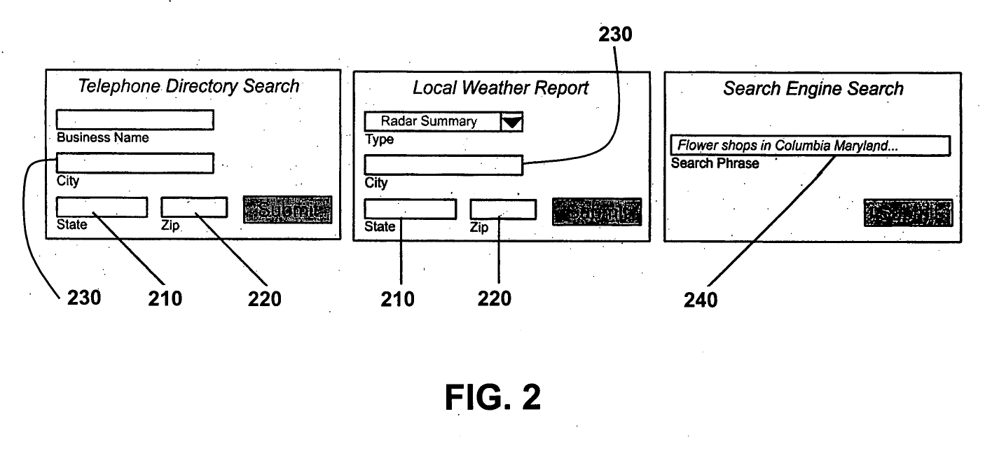

When an end user 100 accesses a web site 130 that allows entry of geographic data, the end user 100 may enter geographic information into a web page and receive information relevant to the end user's 100 location. FIG. 2 shows examples of dialog boxes commonly used for data entry on web sites, with entry boxes for city 230, state 210 zip code 220, and/or keyword search phrases 240.

Returning to FIG. 1, scripts on a web publisher's web site 130 utilizing the present invention respond to user data entry by dynamically building an ad request string 140 and embedding an ad request string 140 in the HTML of a web page that is returned to the end user 100 with the user-requested information. A preferred form of such client-side scripting is javascript. Additionally, data may be inserted in an ad request string by server-side scripts coded in ASP, PHP, Java applets, or any other known CGI.

The ad request string 140 is a URL of a web page or script connected via the internet 120 to a central database of advertiser campaign information, or central ad pool, that resides on one or more ad servers 150. The ad request string 140 may consist of simple HTML links. A typical ad request URL might appear as “http//:ads1.areapoint.com/scripts/getad.asp?site=200456&p=123&geoID=4545AKX8z0487&s=468×60,” with the portion geoID=4545AKX8z0487 containing geographic reference data. The methods used by a publisher to build the ad request string may vary with the methods used for creating the form results page returned to the end user 100 and with other factors. In each case, however, an ad request string 140 containing the available geographic parameters is created in order to retrieve a geographically-targeted advertisement from the central ad pool.

Client-side scripts vary in structure according to data available and the needs of a particular web publisher. For example, Table 1 lists a script used on TVGuide.com to extract the user's zip code from a pre-existing browser cookie set by the web publisher when a user entered a zip code to view local TV listing.

TABLE 1
<script language=“javascript”>
// Copyright 2004 Jeffery V. Howes, all rights reserved
// Custom AreaPoint tag for AccuWX
var AdLoaded = false;
var apz = apgetAWZip(‘adc1’);
var apc = apgetAWCity(‘adc2’)[4];
var aps = apgetAWCity(‘adc2’)[5];
if (apz == null && location.search) apz = apGetLocPar(‘zipcode’)
// var apy = apReadLocal(‘county’);
// var apa = apReadLocal(‘area’);
var bsid = ‘19444’;
var bsads = ‘8’;
var bsloc = ‘test_728’;
bspop = 1;
var bswx = 728;
var bshx = 90;
var bsw = ‘_blank’;
var bsb = ‘FFFFFF’;
var bsf = ‘FF0000’;
var bsalt = ‘off’;
function apgetAWZip(c) {var ap_cname = c + “=”;var ap_dc =
document.cookie;if (ap_dc.length > 0) {ap_begin =
ap_dc.indexOf(ap_cname);
if (ap_begin != −1) {ap_begin += ap_cname.length;ap_end =
ap_dc.indexOf(“;”, ap_begin);
if (ap_end == −1) ap_end = ap_dc.length; var ap_AWZip =
unescape(ap_dc.substring(ap_begin, ap_end));ap_end =
ap_AWZip.indexOf(“|”, ap_AWZip); if (ap_end == −1) ap_end =
ap_AWZip.length;
var ap_zip = unescape(ap_AWZip.substring(0, ap_end));return
ap_zip;}}return null;}
function apgetAWCity(c) {var ap_cname = c + “=”;var ap_dc =
document.cookie;if (ap_dc.length > 0) {ap_begin =
ap_dc.indexOf(ap_cname);if (ap_begin != −1) {ap_begin +=
ap_cname.length;ap_end = ap_dc.indexOf(“;”, ap_begin);
if (ap_end == −1) ap_end = ap_dc.length;var ap_AWCity =
unescape(ap_dc.substring(ap_begin, ap_end));var ap_CSarr =
ap_AWCity.split(“|”);return ap_CSarr;} }retum new Array( );}
function apGetLocPar(apName) {var pageStr =
document.location.search;var idx = pageStr.indexOf(apName +
‘=’);if (idx != −1)
{var pair = pageStr.substring(idx, pageStr.length).substring(0,
pageStr.substring(idx, pageStr.length).indexOf(‘&’)).split(“=”);if
(!pair[1]) pair = pageStr.substring(idx,
pageStr.length).split(“=”);returnpair[1];} else {return“;}}
</script>
<script language=“javascript”
src=“http://www8.bannerspace.com/js/areapoint.js”>
</script>

Table 2 lists a client-side script that deposits no cookie, but parses the geographic parameter “zip” (user zip code) out of a URL string entered by an end user on a weather information web site.

TABLE 2
<script language=“javascript”>
// Copyright 2004 Jeffery V. Howes, all rights reserved
// TVGuide.com live test tag.
// This code retrieves the user's zip code from the existing cookie.
No additional
// configuration is required.
var AdLoaded = false;
var apz = apReadLocal(‘Zip’);
// var ape = apReadLocal(‘city’);
// var apy = apReadLocal(‘county’);
// var apa = apReadLocal(‘area’);
// var aps = apReadLocal(‘state’);
var bsid = ‘19483’;
var bsads = ‘8’;
var bsloc = ‘ros_geo_728’;
bspop = 1;
var bswx = 728;
var bshx = 90;
var bsw = ‘_blank’;
var bsb = ‘eeeaea’;
var bsf = ‘FF0000’;
var bsalt = ‘off’;
function apReadLocal(c) {

var cname = c + “=”;
var dc = document.cookie;
if(dc.length > 0) {

begin = dc.indexOf(cname);

if (begin != −1) {

begin += cname.length;
end = dc.indexOf(“;”, begin);
if (end == −1) end = dc. length;
var retVal = unescape(dc.substring(begin, end));
return retVal;

}

}
return null;

}
</script>
<script language=“javascript”
src=“http://www8.bannerspace.com/js/areapoint.js”>
</script>

In still another example, Table 3 lists a script for another weather site wherein a cookie is checked for zip code, city, and state. If the zip code is not found in the cookie, the document's URL string is checked.

TABLE 3
<script language=“javascript”>
// Copyright 2004 Jeffery V. Howes, all rights reserved
// iframe test tag for WeatherBug.com
// this code should be directly inside the iframe that contains the
parameters in the URL
// change the next line (inside quotes) to match the name of your
zip code parameter
var apz = apGetLocPar(‘zip’);
// var aps = apGetLocPar(‘state’);
// var ape = apGetLocPar(‘city’);
// var apa = apGetLocPar(‘area_code’);
var AdLoaded = false;
var bsid = ‘19495’;
var bsads = ‘8’;
var bsloc = ‘test_728’;
var bspop = 1;
var bswx = 728;
var bshx = 90;
var bsw = ‘_new’;
var bsb = ‘FFFFFF’;
var bsf = ‘FF0000’;
var bsalt = ‘off’;
function apGetLocPar(apName) {

var pageStr = document.location.href;
var idx = pageStr.indexOf(apName + ‘=’);
if (idx != −1) {

var pair = pageStr.substring(idx, pageStr.length).substring(0,

pageStr.substring(idx, pageStr.length).indexOf(‘&’)).split(“=”);

if (!pair[1]) pair = pageStr.substring(idx,

pageStr.length).split(“=”);

return pair[1];
} else {return “;}

}
</script>
<script language=“javascript”
src=“http://www8.bannerspace.com/js/areapoint.js”>
</script>

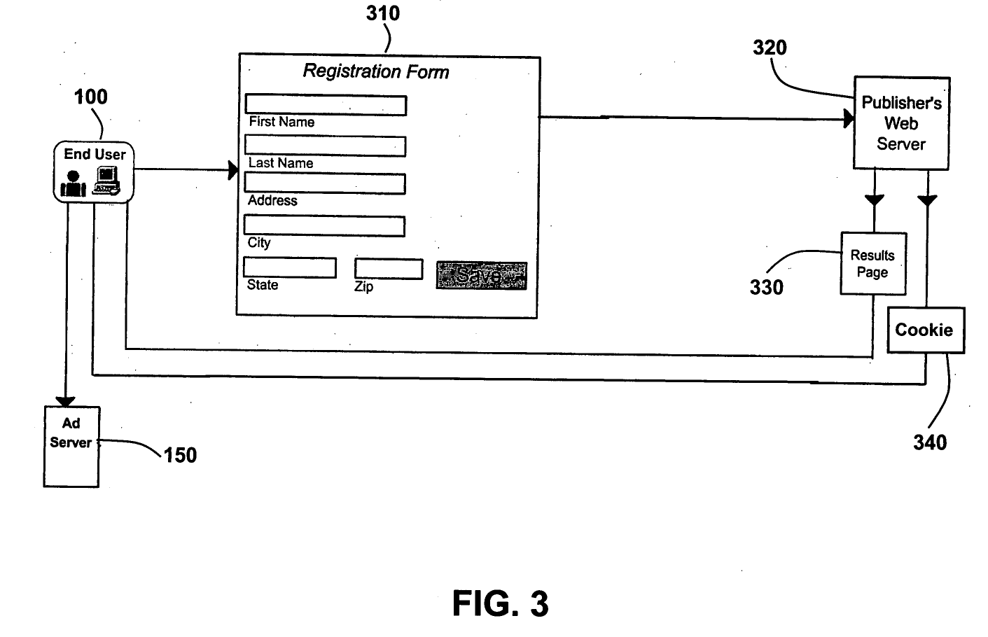

FIG. 3 shows a flow diagram of an embodiment of the present invention wherein geographic information collected on an end user once may be stored on the end user's system in the form of a cookie, so after the end user's first visit to a participating web publisher's site the end user could receive a geographically-targeted ad by visiting a web page that does not have a data-entry form.

In any embodiment of the present invention, data fields left blank may be automatically completed by correlating supplied geographic information with corresponding information in a global geographic information database, provided that the end user entered at least one data type on an initial visit. For example, if the only information provided in the ad request string is the zip code, the system will look up that zip code in the table of all zip codes and extract all of the other fields from the matching record. Therefore, even if a request is made with a zip code, a match can be made with advertisers targeting the user's telephone area code, state, county, region, etc., even if the advertiser has not specifically entered a targeting record for the user's zip code. The same method may be used with any other single parameter supplied in the ad request string.

Also, in any embodiment of the present invention, centralized handling of end user identification data allows an advertising provider to in effect follow an end user from one participating web site to another. An end user who has been geographically located by any participating web site can therefore be subsequently identified and located by any other participating site, regardless of whether or not the end user provides geographic information to a subsequently-accessed site, and an advertising provider may then continue to supply geographically-targeted ads. This capability provides a significant advantage over methods that rely on a cookie written to an end user's system by a single domain, since browser security would normally prevent other domains from reading that cookie.

In the embodiment of FIG. 3, an end user 100 making an initial visit to a web publisher's site completes some portion of a registration dialog box 310. Data from the registration dialog box 310 is transferred to the web publisher's server 320, which responds with both a results page 330 and a cookie 340 containing geographic data on the end user 100. The cookie 340 is stored on the end user's system. When the end user 100 subsequently visits any web page provided by a participating web publisher, a script on a web publisher's page first determines whether a cookie is available. If so, the script builds the ad request string and retrieves an ad from the ad server 150.

In still another embodiment of the present invention, geographic data corresponding to an end user may be inferred when the end user visits a web site with a geographically-defined audience, even when no data entry form is provided on the web site. FIG. 1 depicts such a web site with local content 160. In this case, the web site operator would “hard code” geographic parameters into an ad request string instead of dynamically appending them through a script or other means.

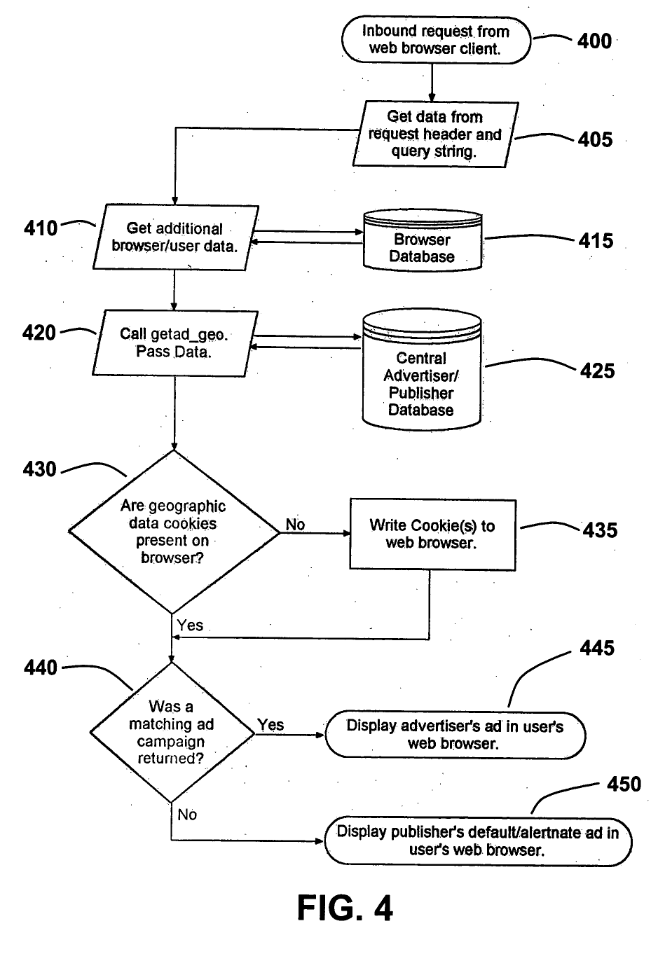

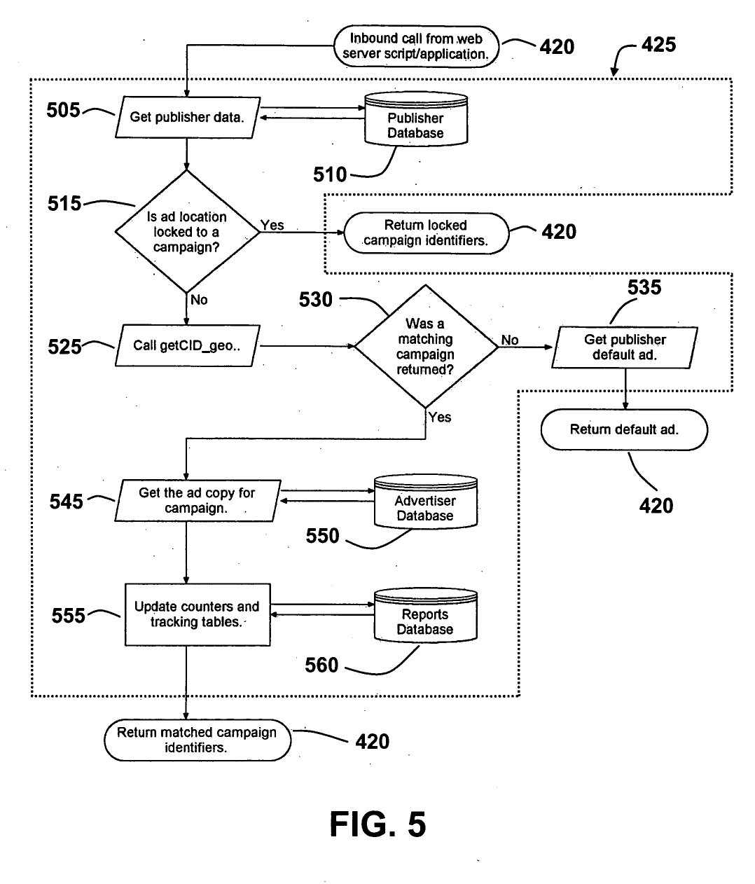

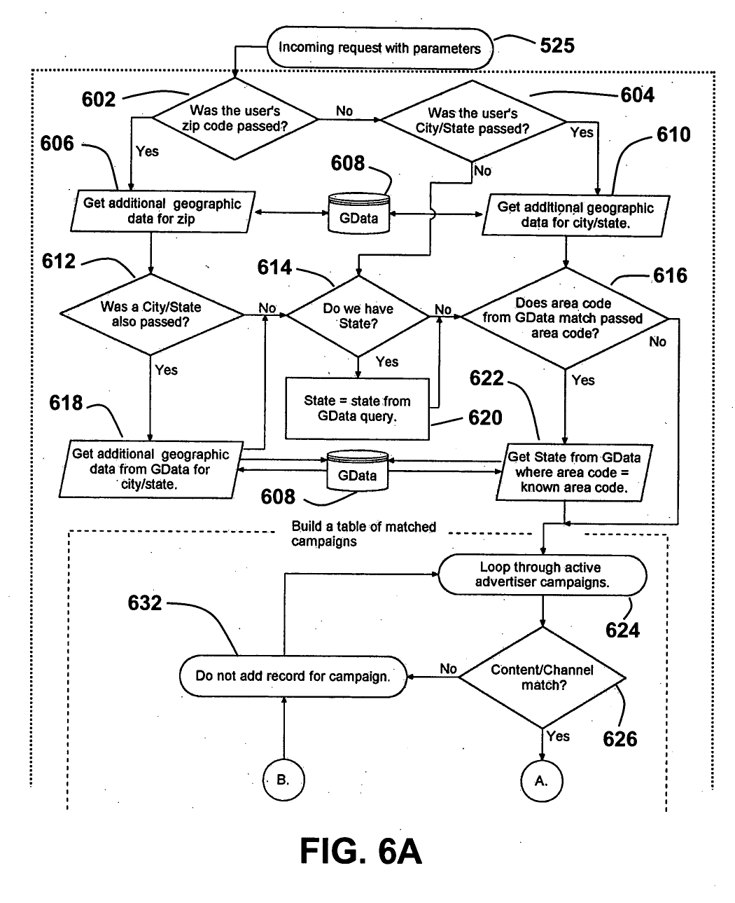

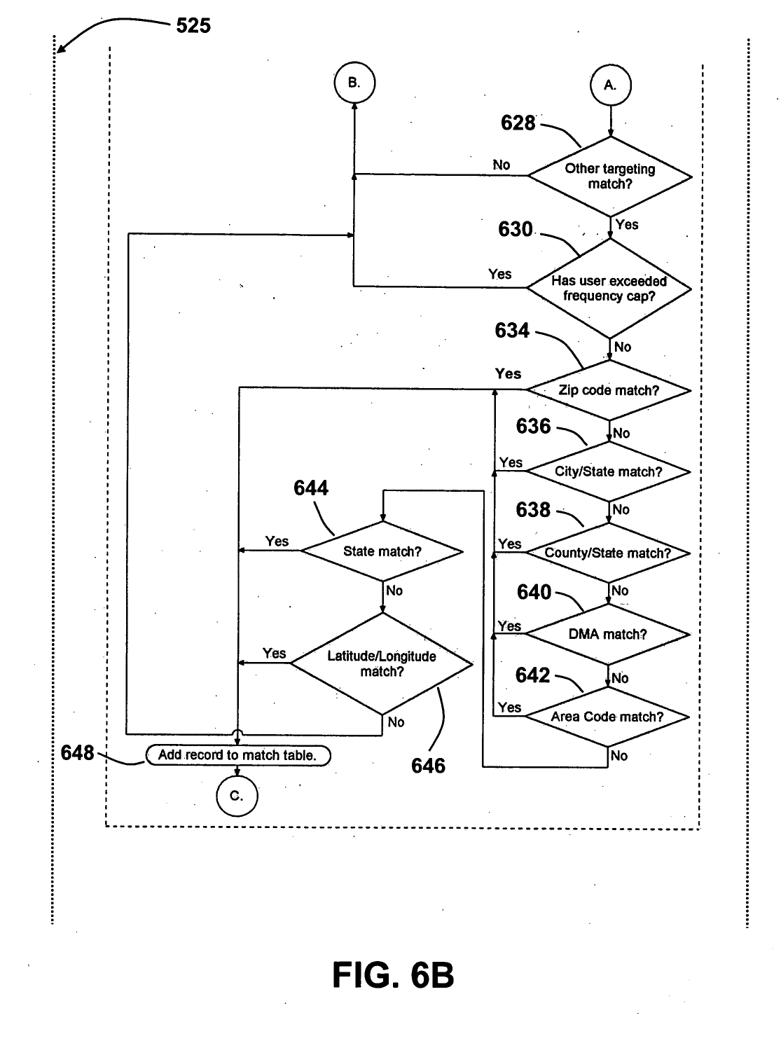

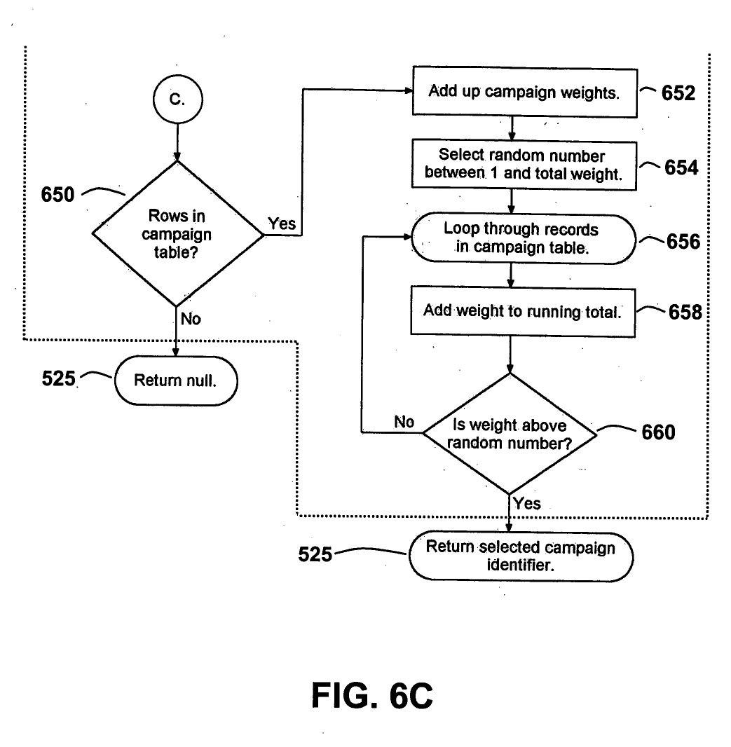

The preferred embodiment of FIG. 4 is an ASP script that connects to a database and passes the parameters to a stored procedure, which is a block of pre-compiled code located on the database server or servers. The script of FIG. 5 receives and parses user ID and other parameters from a participating web site, retrieves web publisher data from a database on the database server or servers, and calls the script of FIG. 6 to match end users to relevant advertising campaigns. If no matches are found, a default ad is returned. If a match is found, geographically targeted advertising is returned.

FIG. 4 shows a flow diagram for a script that a web publisher would point to with an ad request string 140. An example of the script of FIG. 4 is coded in ASP/VBScript and titled “geoad_html.txt” in a computer program listing appendix appended on compact disc to the present application. Such a script may be written any programming language capable of running on the ad server 150, connecting to the database, and sending an ad request response to an end user 100 via the Internet 120. The role of the script is that of a “web gateway,” or means to access a database from a web page. As with any web gateway, the code must parse the request and format the variables in the request into a command or query recognized by a database. Upon receiving the results of a database transaction, the script will have the necessary pieces of data to format and return a response to the end user 100 that initiated the ad request.

As shown in FIG. 4, an ad request string 400 is received by an ad server 150 (shown in FIG. 1) from a web browser client and parsed 405 to obtain an ad request code and query string. Incomplete browser and user data may be supplemented 410 from a browser database 415. Browser and user data are passed by getad_geo.sql 420 (a subprogram described in detail below) to an advertiser/web publisher database 425 on a central ad server 150 (shown in FIG. 1) and appropriate advertising content is retrieved. The end user's browser 100 (shown in FIG. 1) is tested for the presence of geographic cookies 430. A geographic cookie allows the present invention to store the most complete set of geographic data available for an end user on the end user's system, so that the present invention, may continue to provide the most geographically appropriate content to the end user even when the end user accesses web pages that provide little or no data. If no cookie is present and the end user's browser will accept a cookie, a cookie containing all geographic data pertaining to the user is written 435 to the end user's browser cookie folder.

The advertising content and web publisher data retrieved from the advertiser/web publisher database 425 is compared to user data to determine whether any matching advertising campaign 440 exists. If so, the ads in the campaign are displayed 445 by the user's browser. If not, a default ad is displayed 450.

FIG. 5 shows a flow diagram for getad_geo.sql, which is called by geoad_html.asp. An example of the script of FIG. 5 is coded in SQL and titled “getad_geo.txt” in a computer program listing appendix appended on compact disc to the present application. Such a script may be written any programming language capable of running on the ad server 150, connecting to the database, and sending an ad request response to an end user 100 via the Internet 120.

As shown in FIG. 5, a call 420 from geoad_html.asp passes data 405, 410 to a server database 425. Publisher data is retrieved 505 from a publisher database 510. Web publisher data is compared 515 to user data to determine whether the location is locked to a particular advertising campaign. If so, locked campaign identifiers are returned 420. Otherwise, user and publisher data are passed to getCID_geo_nopop.sql 525 (described in detail below) to retrieve geographically appropriate advertising campaigns.

If no matching campaign is returned 530, default advertising selected by the web publisher is retrieved 535 and passed back 420. Otherwise, appropriate advertising copy is retrieved 545 from an advertiser database 550. Counters and tracking tables accumulate usage data 555 for reports and billing in a reports database 560, then matching campaign identifiers are returned 420.

FIGS. 6A, 6B, and 6C show a flow diagram for getCID_geo_nopop.sql, which is a script called by getad_geo.sql. An example of the script of FIGS. 6A, 6B, and 6C is coded in SQL and titled “getCID_geo_nopop.txt” in a computer program listing appendix appended on compact disc to the present application. Such a script may be written any programming language capable of running on the ad server 150, connecting to the database, and sending an ad request response to an end user 100 via the Internet 120.

As shown in FIGS. 6A, 6B and 6C, data passed 525 by getad_geo.sql is sequentially tested for geographic parameters ranging from geographically narrowest to broadest and supplemented where possible. The general purpose of this processing phase is to build the most complete user record possible by correlating supplied and inferred data with a database of related geographic data. If the end user's zip code was passed 602 the data are supplemented 606 with related geographic data from a geographic database 608, including geographic coordinates where available. The presence of combined city and state data is tested 612 and, if present, supplemented 618, 608. Whether or not combined city and state data are present, the presence of state data is tested 614 and, if present, supplemented 620 with geographic data already retrieved. Whether or not state data are present, an area code already retrieved is, if present, compared 616 with any area code passed with user data for a match and, if present, supplemented 622, 608.

If no zip code is present, the presence of combined city and state data is tested 604 and, if present, supplemented 610, 608, then compared 616 with any area code passed with user data for a match, if present, supplemented 622, 608. If combined city and state data are not present, the presence of state data is tested 614 and, if present, supplemented 620, then compared 616 with any area code passed with user data for a match, if present, supplemented 622, 608.

Once the variety and quality of data have been enhanced as much as possible, the data are compared iteratively 624 to a sequence of parameters of each advertising campaign to determine which campaigns are appropriate for the end user's geographic location. If user data do not match the content and advertising parameters 626 and other selected targeting parameters 630 for a given campaign, [these should be described in more detail] or if the user has exceeded a selected frequency cap [selected by whom, and for what reason?], no record of the campaign is associated 632 with the user data in a match table.

Otherwise, user data is compared sequentially to data for each advertising campaign such as zip code 634, combined city and state 636, combined county and state 638, DMA 640, area code 642, state only 644, and latitude and longitude coordinates 646. If a match is found with any of these parameters, a record of the campaign being tested is added 648 to a match table associated with the user data. Conversely, if no match is found with any parameter, no record of the campaign is associated 632 with the user data in the match table.

When all user data has been compared to parameters for each active advertising campaign, the campaign match table 650 is tested for the presence of campaign records. If no records are found, a null result is returned 525. If records are present, one record is selected for return viewing by the end user. Weight factors previously assigned to each campaign are added 652, an integer between one and the sum of all weights is randomly selected 654, a first record from the match table is selected, the weight for the selected record is added to a running total 658, and the weight of the running total is compared 660 to the previously-selected random number. If the weight exceeds the random number, the selected record from the match table is returned 525. If not, another record is selected 656 from the match table and the process is repeated until a record is returned 525.

The scripts shown in FIGS. 4, 5, 6A, 6B, and 6C utilize information stored in data tables that may reside on an ad server 150 or other system. Data tables utilized in a preferred embodiment of the present invention may store information for advertiser accounts, campaign targeting preferences including geographic targeting, creative specifications, publisher accounts, publisher audience data such as demographics, global geographic information such as zip codes, area codes, cities, states, regions, and their associated longitude and latitude, advertiser names, addresses, phones numbers, and information that is outside the scope of basic geographic ad targeting.

Table 4 shows a geographic data table referred to in preceding scripts as “Gdata.” This data may be purchased directly from the U.S. postal service or many other commercially available sources. Table 5 shows a geographic targeting table referred to in preceding scripts as “Gtarget.” A record is inserted into this table for each unique area an advertiser is targeting. Such tables can be adapted by known means to suit the requirements of any planned campaigns, and Tables 4 and 5 merely show samples of possible table structure and contents.

TABLE 4

| Field | Type | Description |
|---|---|---|
| Zip | varchar | |
| State | varchar | |
| County | varchar | |
| City | varchar | |
| Area_Code | char | |
| DMA_Code | varchar | Direct Market Area |
| Longitude | float | used in ranges or radius targeting |
| Latitude | float | used in ranges or radius targeting |
| Time Zone | char | |
| Daylight Savings | char | |

TABLE 5

| Field | Type | Description |
|---|---|---|
| RID | Int | unique identifier |
| CID | Int | advertiser account ID number |
| Zip | varchar | |
| State | char | |
| County | varchar | |
| City | varchar | |
| Area_Code | char | |
| DMA_Code | varchar | Direct Market Area |
| Distance | Int | defines the distance (in miles) from a central |
| | | zip code to be targeted |
| MinLon | float | These are the minimum and maximum |
| MaxLon | float | longitude and latitude used to define a range, |
| MinLat | float | based on the distance from a central point. |
| MaxLat | float | |

When an advertiser or other system operator saves a new target area, a new record is created in the Geographic Targeting table shown in Table 6. Depending on the input, a record will contain a zip code, area code, state, city, county or DMA, or a combination of more than one of these fields. If the advertiser is targeting a radius from a central zip code, the minimum and maximum longitude and latitude fields will be calculated using an algorithm such as the one shown in Table 6. In Table 6, @Lat and @Lon are the latitude and longitude of the central point, @Miles is the radius distance specified.

TABLE 6

MaxLat = @Lat + ((@Miles/69.1))
MinLat = @Lat − ((@Miles/69.1))
MaxLon = @Lon + ((@Miles/69.1))* cos(@Lat/57.3))
MinLon = @Lon − ((@Miles/69.1))* cos(@Lat/57.3))

When an ad server receives user and web publisher parameters from the web database gateway script, the geographic parameter(s) is/are first matched with the global geographic data table to obtain other possible target parameters for the user. Then, using an SQL SELECT and JOIN statement, a temporary list (table) is built containing a record for each campaign match found. From the resulting table, a single advertiser is selected, based on random algorithms and other system parameters. The selected advertiser ID is then used to retrieve other information needed to display the ad, such as the advertisement creative materials, and the results are returned to the web based script on the ad server, which, in turn, writes the necessary code to display the advertisement to the user's browser.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

1. A method of supplying advertising information to a computer user, comprising:
receiving advertising information from and at least one geographic selection parameter from an advertiser;
storing the advertising information and at least one geographic selection parameter on an advertising server;
receiving an advertising request character string;
extracting geographic user data from the advertising request character string;
comparing the geographic user data to the at least one geographic selection parameter; and
retrieving the advertising information from the advertising server and transmitting the advertising information to the computer user if the geographic user data matches the at least one geographic selection parameter.

2. A method as claimed in claim 1, further comprising correlating the geographic user data with geographic location data stored in a first geographic database and supplementing the geographic user data with geographically related data from the first geographic database.

3. A method as claimed in claim 1, further comprising:
calculating the geographic coordinates of an advertising target;
defining a geographic region within a specified distance of the geographic coordinates;
calculating minimum and maximum geographic coordinate values occurring within the geographic region;
comparing the geographic user data to the minimum and maximum geographic coordinate values occurring within the geographic region; and
retrieving the advertising information from the advertising server and transmitting the advertising information to the computer user if the geographic user data matches a value between the minimum and maximum geographic coordinate values occurring within the geographic region.

4. A system for supplying advertising information to at least a first computing device, comprising:
an advertising server, the advertising server having means for receiving and storing advertising information and at least one geographic selection parameter, the advertising server having means for receiving a character string, the advertising server having means for extracting geographic user data from the character string, the advertising server having means for comparing the geographic user data to the at least one geographic selection parameter, the advertising server having means for transmitting the advertising information to the first computing device.

5. A system as claimed in claim 4, wherein the first computing device comprises web browsing means and is operable to receive and transmit data via the internet.

6. A system as claimed in claim 5, further comprising a second computing device, the second computing device operable to receive geographic user data from the first computing device via the internet and transmit the character string to the advertising server via the internet.

7. A computer device comprising:
A computer readable medium having computer readable program means embodied therein, the computer readable medium comprising means for:
receiving advertising information and at least one geographic selection parameter from an advertiser;
storing the advertising information and at least one geographic selection parameter on an advertising server;
receiving an advertising request character string;
extracting geographic user data from the advertising request character string;
comparing the geographic user data to the at least one geographic selection parameter; and
retrieving the advertising information from the advertising server and transmitting the advertising information to the computer user if the geographic user data matches the at least one geographic selection parameter.

8. A computer device as claimed in claim 7, wherein the computer readable medium further comprises means for correlating the geographic user data with geographic location data stored in a first geographic database and supplementing the geographic user data with geographically related data from the first geographic database.

9. A computer device as claimed in claim 8, wherein the computer readable medium further comprises means for:
calculating the geographic coordinates of an advertising target;
defining a geographic region within a specified distance of the geographic coordinates;
calculating minimum and maximum geographic coordinate values occurring within the geographic region;
comparing the geographic user data to the minimum and maximum geographic coordinate values occurring within the geographic region; and
retrieving the advertising information from the advertising server and transmitting the advertising information to the computer user if the geographic user data matches a value between the minimum and maximum geographic coordinate values occurring within the geographic region.
